(19) United States
(12) Patent Application Publication
(10) Pub. No.: US 2026/0105179 A1
(43) Pub. Date: Apr. 16, 2026

(54) File Segmentation for Secure Data Storage

(71) Applicant: INTERNATIONAL BUSINESS MACHINES CORPORATION, ARMONK, NY (US)

(72) Inventors: Jessica NAHULAN, Vaughan (CA); Tiberiu SUTO, Franklin, NY (US); Sonny Z. ZHAN, Cape Coral, FL (US); Jared MONTANARO, Denver, NC (US)

(21) Appl. No.: 18/917,111

(22) Filed: Oct. 16, 2024

(51) Int. Cl. G06F 21/62; G06F 21/60

(52) U.S. Cl. CPC G06F 21/6227; G06F 21/602

(57) ABSTRACT

Described are techniques for securing content data contained in file segments. The techniques include inferring security separation boundaries in a file to define file segments of content data, where the inferring is performed by one or more artificial intelligence (AI) models trained to infer the security separation boundaries of the file segments based on an inferred importance of the content data contained within the file segments. The techniques further include generating content security scores for the file segments, where the generating is performed by the one or more AI models trained to generate the content security scores based at least in part on the inferred importance of the content in the file segments. The techniques further include assigning security tiers to the file segments that correspond to the content security scores and storing the file segments according to the security tiers assigned to the file segments.

### BACKGROUND

The present disclosure relates to data security systems, and, more specifically, to applying security protocols to content data.

Data security systems are comprehensible frameworks designed to protect digital information from unauthorized access, corruption, or theft throughout the life cycle of the digital information. Data security systems encompass a wide range of measures, including the physical security of hardware and storage devices, administrative and access controls, and the logical security of software applications. Key components of data security systems include encryption, data masking, and redaction to remove sensitive data from documents. Additionally, robust data security strategies involve continuous monitoring and auditing to detect and respond to potential threats promptly. Compliance with regulations can also be crucial, as these regulations mandate specific protections for personal and sensitive data.

### SUMMARY

Aspects of the present disclosure are directed toward a computer-implemented method for securing content data contained in a file segment. The computer-implemented method comprising inferring security separation boundaries in a file to define file segments of content data, where the inferring is performed by one or more artificial intelligence (AI) models trained to infer the security separation boundaries of the file segments based on an inferred importance of the content data contained within the file segments. The computer-implemented method further comprising generating content security scores for the file segments, where the generating is performed by the one or more AI models trained to generate the content security scores based at least in part on the inferred importance of the content in the file segments. The computer-implemented method further comprising assigning security tiers to the file segments that correspond to the content security scores generated for the file segments, the security tiers specifying security protocols for storing the file segments, and storing the file segments according to the security tiers assigned to the file segments.

Additional aspects of the present disclosure are directed to systems and computer program products configured to perform the methods described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 is a block diagram illustrating an example system for intelligently dividing a file into file segments and assigning security tiers to the file segments, in accordance with some embodiments of the present disclosure.

FIG. 2 is a diagram that illustrates an example of assigning file segments to different security tiers, in accordance with some embodiments of the present disclosure.

FIG. 3 illustrates an example of a metadata file containing metadata for individual file segments, in accordance with some embodiments of the present disclosure.

FIG. 4 is a flow diagram illustrating an example method for securing content data contained in a file segment, in accordance with some embodiments of the present disclosure.

FIG. 5 is a flow diagram that illustrates an example method for updating a content security score for a file segment, in accordance with some embodiments of the present disclosure.

FIG. 6 is a block diagram that illustrates an example computing environment in which aspects of the present disclosure can be implemented, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

The present disclosure is directed to intelligently securing individual file segments in a file based on a determination of importance of content data contained in the file segments. Namely, aspects of the present disclosure intelligently divide a file into file segments based on a determination of importance of content data in the file segments, and assign security tiers to the file segments to correspond to the importance of the content data in the file segments. The term “content data”, as used herein, can be any type of digital data contained in an electronic file that conveys information, meaning, or purpose. The term “importance” in the context of content data comprises a measure of the content data’s value to an organization and/or individual, and a risk of the content data being lost and/or exfiltrated. While not limited to such applications, embodiments of the present disclosure may be better understood in light of the following context.

As reliance on digital data increases, so does the complexity and volume of the digital data. Traditional data security systems have typically employed a static approach, applying uniform protective measures to all data, regardless of the varying importance and/or sensitivity of the data. This one-size fits-all strategy is proving increasingly ineffective in the ever-evolving digital landscape where the importance and sensitivity of data can significantly fluctuate over even small periods of time. These fluctuations may be influenced by factors that include market trends, customer requirements, regulatory changes, and technological advancements. For example, when it comes to securing information contained in a file, data storage systems have traditionally applied a single security standard or protocol to the file as a whole, even in those cases where only a portion of content data in the file warrants a higher security rating, such as in a single file where not all content data in the file is of the same importance. As an illustration, a first section of a file may contain content data that is of high importance, whereas a second section of the file may contain content data that is of low importance. Because traditional security systems treat content data uniformly, a higher security protocol is likely to be used for storing the file even though the second section of the file does not include high importance content data. This approach is inefficient and can lead to the over-protection of low importance content data or under-protection of high importance content data. Moreover, in scenarios where content data in a file evolves over time (e.g., gaining or losing importance), static security measures used to store the file become obsolete, which can result in inefficient data storage practices and/or high importance content data vulnerable to loss and/or exfiltration.

Because the static nature of traditional data security systems hinders their agility in storing content data that is of varying importance, a more dynamic and intelligent data security system is needed. Advantageously, aspects of the present disclosure address the challenge of storing content data contained in a file when the content data varies in importance by intelligently segmenting the file into file segments based on an importance of content data contained in the file segments, and thereafter, for each file segment, assigning a security tier to the file segment that corresponds to an importance of the file segment. This is an improvement over traditional data security systems because the content data of the individual file segments is secured using a security tier that is appropriate for the content data, whereas the traditional data security systems apply the same security protocol to all content data in a file. Moreover, aspects of the present disclosure provide improvements over traditional data security systems by automatically, and intelligently, reevaluating file segments to determine whether a current security tier assigned to the file segment continues to be appropriate based on the importance of the content data in the file segment.

Also, segmenting a file into file segments and individually storing the file segments to datastores that implement an assigned security tier improves a data security system’s utilization of its computer resources. Specifically, storing high importance content data is expensive in the context of the computer resources used for storing and maintaining the content data because of the need for robust security measures, high availability, redundancy to prevent data loss, long-term retention policies, and often the need for fast access speeds. By segmenting a file’s high importance content data from lower importance content data, the amount of computer resources used for storing the high importance content data is reduced because the lower importance content data is not stored using these computer resources.

Accordingly, securing individual file segments according to an importance of content data contained in the file segments is an improvement in the technical field of data security generally, and more particularly, in the technical field of artificial intelligence and machine learning to intelligently divide a file into file segments based on an importance of content data contained in the file segments, and assign a security tier to the file segments that corresponds to the importance of the content data contained therein. These advantages, as well as other advantages of the present disclosure are described below.

According to an aspect of the present disclosure, there is provided a computer-implemented method for securing content data contained in a file segment, comprising inferring security separation boundaries in a file to define file segments of content data, where the inferring is performed by one or more artificial intelligence (AI) models trained to infer the security separation boundaries of the file segments based on an inferred importance of the content data contained within the file segments. The computer-implemented method further comprising generating content security scores for the file segments, where the generating is performed by the one or more AI models trained to generate the content security scores based at least in part on the inferred importance of the content in the file segments. The computer-implemented method further comprising assigning security tiers to the file segments that correspond to the content security scores generated for the file segments, the security tiers specifying security protocols for storing the file segments, and storing the file segments according to the security tiers assigned to the file segments. Advantageously, these aspects of the computer-implemented method have the technical effect of securing individual segments of a file according to an importance of the content data contained in the individual file segments, thereby better aligning security protocols to content data in the file, and allowing for improved allocation of computer resources for storing and maintaining the file.

According to an aspect of the computer-implemented method, storing the file segments according to the security tiers further comprises encrypting file segments assigned to a security tier that specifies an encryption technique for securing the file segments. Advantageously, this aspect of the computer-implemented method has the technical effect of securing content data using encryption when specified by a security tier, and not encrypting content data when not specified by a security tier so as to decrease an amount of computer resources that would otherwise be used to perform the encrypting.

According to an aspect of the computer-implemented method, the method further comprises generating metadata for a file segment to include information selected from the group consisting of: a content security score; a last assessment timestamp; and file segment offsets for the file segment. Advantageously, this aspect of the computer-implemented method has the technical effect of generating information for a file segment that enables a data security system to manage security of the file segment, thereby enabling the improvements described herein.

According to an aspect of the computer-implemented method, the method further comprises encrypting the metadata for the file segment and storing the metadata separate from the file segment. Advantageously, this aspect of the computer-implemented method has the technical effect of separating the metadata from the file segment and protecting the metadata using encryption, thereby improving the overall security of the file segment.

According to an aspect of the computer-implemented method, the method further comprises storing the metadata for the file segment in the file segment according to the security tier assigned to the file segment. Advantageously, this aspect of the computer-implemented method has the technical effect of storing the file segment and its metadata together to simplify storage and retrieval of the file segment.

According to an aspect of the computer-implemented method, the method further comprises monitoring a dedicated file directory and, responsive to detecting that the file has been placed in the dedicated file directory, securing the content data contained in the file using the techniques described herein. Advantageously, this aspect of the computer-implemented method has the technical effect of automating file security, such that files placed into the dedicated file directory are automatically secured using the file segmenting techniques described herein.

According to an aspect of the computer-implemented method, the method further comprises determining that a file segment of the file is tagged with a description identifier that indicates, at least in part, an importance of content data contained in the file segment, and generating a content security score for the file segment based at least in part on the importance of the content data indicated by the description identifier. Advantageously, this aspect of the computer-implemented method has the technical effect of assigning a security tier to a file segment that better corresponds to the content data of the file segment. That is, the tag provides additional information about the content data that can be used to better align an assignment of a security tier to the file segment, thereby realizing the improvements described herein.

According to an aspect of the computer-implemented method, the method further comprises determining that content data in a file segment has been modified, generating an updated content security score for the file segment, where responsive to a determination that the updated content security score corresponds to a security tier that is different from a currently assigned security tier, reassigning the file segment to the security tier that corresponds to the updated content security score, and storing the file segment according to the security tier that corresponds to the updated content security score. Advantageously, this aspect of the computer-implemented method has the technical effect of automatically aligning a security tier to the current content data of a file segment, such that a security tier assignment is automatically updated in response to a modification of content data in a file segment, thereby improving the overall security of the file segment.

According to an aspect of the computer-implemented method, inferring an importance of a file segment further comprises making inferences for the features selected from the group consisting of: a content value of the file segment, a risk level based on a current security protocol implemented for the file segment, an impact cost of a data exfiltration and/or a data loss event, and a data cost for creating and/or obtaining the content data contained in the file segment. Advantageously, this aspect of the computer-implemented method has the technical effect of improving a prediction of importance by enriching a dataset with related features.

Additional aspects of the present disclosure are directed to systems configured to perform any of the functionality of any of the aspects of the aforementioned computer-implemented method, thereby realizing the associated advantages, improvements, and/or technical effects, previously described. Also, additional aspects of the present disclosure are directed to computer program products comprising one or more computer-readable storage media, and program instructions collectively stored on the one or more computer-readable storage media, the program instructions configured to cause one or more processors to perform any of the functionality of any of the aspects of the aforementioned system, thereby realizing the associated advantages, improvements, and/or technical effects, previously described.

Aspects of the present disclosure can be relevant to multiple technical use cases. In one example technical use case, the techniques described herein can be integrated into an enterprise’s data management platform and data storage system to dynamically protect the enterprise’s data while avoiding overprotection or under-protection of their data. For example, the aspects of the present disclosure which determine the importance of a file’s content data, divide the file into file segments based on importance, and assign the file segments to security tiers that correspond to the importance of the file segments can be integrated into the enterprise’s data management platform, and the enterprise’s data storage system can implement the security tiers, such that file segments are transferred to storage servers that implement the security tiers to ensure that the file’s content data is appropriately protected.

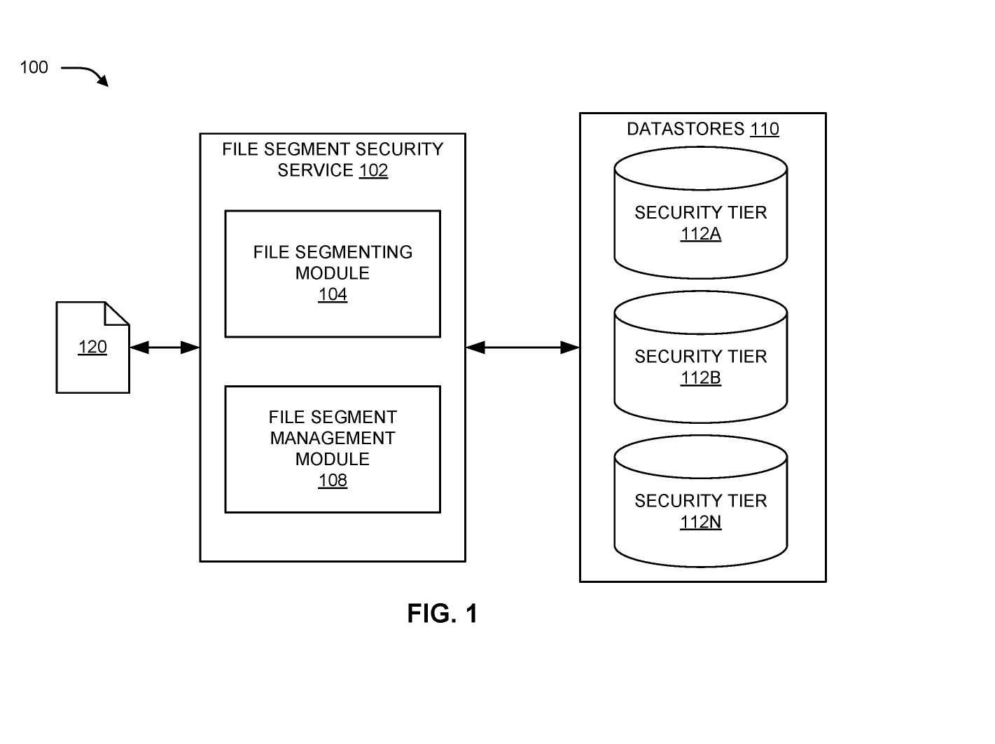

Referring now to the figures, FIG. 1 illustrates a block diagram of an example system 100 for intelligently dividing a file into file segments based on an importance of content data contained in the file segments and assigning security tiers to the file segments that correspond to the importance of the content data in the file segments, in accordance with some embodiments of the present disclosure. The term “intelligently” and “intelligent computing”, as used herein, refers to the use of technologies such as artificial intelligence (AI), natural language processing (NLP), natural language understanding (NLU), machine learning based on neural networks, and cybersecurity to process and analyze multidimensional data.

A file 120 can contain content data that conveys information, meaning, or purpose. The content data can be unprocessed or processed, and can include metadata. Illustratively, types of content data can include: public data that is generally available to the public; internal-only data that is restricted to an organization’s internal employees (e.g., intellectual property); confidential data that requires clearance to access; restricted data, such as government information that only authorized individuals can access; high sensitivity data, such as financial records, authentication data, or intellectual property, which could have a catastrophic impact on an organization if compromised or destroyed; medium sensitivity data intended for internal use only, but if compromised or destroyed, may not have a catastrophic impact on the organization; low sensitivity data that can be for public use, such as public website content; data that is specialized, exclusive, hard to obtain or replace; as well as other types of data known to persons of ordinary skill. Content data can be embodied in text, numerals, images, graphs, tables, objects, and the like.

A file 120 can contain multiple types of content data of varying importance, and different sections of the file 120 can contain content data of different importance. For example, content data of different importance can be located in a page, a sequence of pages, a paragraph, a sequence of paragraphs, and/or a portion of a paragraph. Because different sections of a file 120 can contain different types of content data of different importance, applying a same security protocol to all content data in a file 120 can result in the over-protection of low importance content data, or under-protection of high importance content data. The system 100 addresses these issues by intelligently dividing a file 120 into file segments based on content data importance and assigning security tiers 112A, 112B, 112N (collectively 112, where N can refer to any positive integer representing any number of security tiers) to the file segments to correspond to the importance of the content data in the file segments.

As shown in FIG. 1, the system 100 implements a file segment security service 102. As described in more detail below, the file segment security service 102 intelligently divides a file 120 into individual file segments based on an assessment of the importance of content data contained in the individual file segments, and assigns security tiers 112 to the individual file segments to correspond to the assessed importance of the content data. The importance of content data can be a measure of the content data’s value to an organization and/or individual, and a risk of loss and/or exfiltration of the content data. As will be described in more detail below, this measure of importance can be based on a number of factors related to the content data’s value and risk.

In this illustrative example, the file segment security service 102 includes a file segmenting module 104, a file segment management module 108, and other modules as will be appreciated by persons of ordinary skill.

The file segmenting module 104 intelligently divides a file 120 into a plurality of file segments based on an assessment of importance of content data contained in the file 120. As part of dividing the file 120 into the file segments, the file segmenting module 104 generates content security scores for the file segments which are used to determine security tiers 112 to assign to the file segments.

The file segmenting module 104 comprises one or more AI models trained to determine an importance of content data in a file 120 and divide the file 120 into file segments based on the importance. In some embodiments, the file segmenting module 104 can classify the content data of a file 120 into different content categories (e.g., public data, internal-only data, confidential data, high sensitivity data, medium sensitivity data, low sensitive data, specialized data, etc.) and determine an importance of the classified content data. As an example, the file segmenting module 104 can evaluate content data contained in a portion of a file 120 (e.g., a page, a sequence of pages, a paragraph, a portion of a paragraph, and/or a sequence of paragraphs) and classify the content data as a category of content data, and determine an importance of the content data using a set of data importance indicators. This can be repeated for each portion of the file 120 (or alternatively, for selected portions of the file 120). The file offsets of the content data that has been classified are security separation boundaries that define file segments.

In some embodiments, a topic modeling technique can be used to identify the file segments. In general, topic modeling utilizes natural language processing (NLP) and a text mining technique that applies unsupervised learning on files 120 to produce a summary set of terms derived from those documents that represent the collection’s overall primary set of topics. Topic models specifically identify common keywords or phrases in a text dataset and group those words under a number of topics. Topic models thereby aim to uncover the latent topics or themes characterizing a file 120. In this way, topic models are a machine learning-based form of text analysis used to thematically annotate files. In some embodiments, latent semantic analysis (LSA) (also called latent semantic indexing) can be used to identify file segments in a file 120. LSA deploys a technique known as singular value decomposition in order to reduce sparsity in the document-term matrix. In some embodiments, latent Dirichlet allocation (LDA) can be used to identify file segments in a file 120. LDA is a probabilistic topic modeling algorithm that generates topics, classifying words and documents among these topics, according to probability distributions. Using the document-term matrix, LDA generates topic distributions (that is, lists of keywords with respective probabilities) according to word frequency and co-occurrences. This assumption is that words that occur together are likely a part of similar topics. LDA assigns document-topic distributions based on the clusters of words that appear in the given document.

In some embodiments, file segmenting module 104 comprises a set of AI models configured to divide a file 120 into file segments based on an importance of content data. The set of AI models can identify file segments based on probabilities associated with different types of content data, where these probabilities can be regarded as probabilities of occurrence or completion, which can be determined using a language model. A language model is a probabilistic model of a natural language, which can be used to generate text based on probabilities of textual signs. As a non-limiting example, a first AI model in the set of AI models can be a large language model (LLM) that is parameterized to extract probabilities of successive words or sentences forming a file segment. The probability of occurrence of a file segment can be formulated as a product or a weighted sum of products of probabilities of the successive file segment. A second AI model in the set of AI models can determine a probability that word frequencies constitute a file segment, where the probability associated with each file segment can be formulated as a product (or a sum of products) of the average frequencies of the words involved in the file segment. A third AI model in the set of AI models can determine a word count the constitutes a file segment. A fourth AI model can determine a probability that character frequencies constitute a file segment, where the probability associated with each file segment is formulated as a product (or a weighted sum of products) of average frequencies of the characters involved in a file segment. A fifth AI model can determine a probability that a character count constitutes a file segment, where the scope of the file segment can be calculated as the reciprocal of the number of characters multiplied by a multiplicative factor. The probabilities produced by these AI models can be used to make a final file segment determination, and an additional AI model in the set of AI models can determine a probability of importance of the file segment. For example, the additional AI model can classify the content data of a file segment (e.g., classify as public data, internal-only data, confidential data, high sensitivity data, medium sensitivity data, low sensitive data, specialized data, etc.) and then determine an importance of the classified content data using the set of data importance indicators described below.

Referring again to FIG. 1, as mentioned above, as part of dividing a file 120 into file segments, the file segmenting module 104 generates content security scores for individual file segments. In some embodiments, a set of data importance indicators can be used to generate the content security scores. The data importance indicators can represent different features of content data contained in a file segment. As a non-limiting example, the features represented by data importance indicators can include: a content category (e.g., public data, internal-only data, confidential data, high sensitivity data, medium sensitivity data, low sensitive data, specialized data, etc.), age and/or relevance of content at a specified point-in-time; an amount of resources expended to generate/obtain content data; risks associated with the loss of, or the exfiltration of, content data (e.g., financial losses, productivity disruptions, reputational damage, legal consequences, etc.); an author of content data; a job role of an author of content data; and other features that can be represented by data importance indicators, as known to persons of ordinary skill.

The data importance indicators can be assigned values that signify the importance of content data within the context of the data importance indicators. That is, a value assigned to a data importance indicator signifies an importance of the content data in the context of the feature represented by the data importance indicator. As an example, a data importance indicator representing a risk of loss and/or exfiltration of content data can be assigned a value that represents the risk. The value assigned to the data importance indicator can be a high value when the risk is high, and the value can be a low value when the risk is low.

The file segmenting module 104 can assign values to a set of data importance indicators for a file segment based on an evaluation of the content data in the file segment, and the file segmenting module 104 can calculate a content security score for the file segment based on the values of the set of data importance indicators. The resulting content security score can then be used to determine a security tier to apply to the file segment. As a simplified illustration of generating a content security score for a file segment, the following example values can be assigned to a set of data importance indicators for a file segment: content category = high sensitivity data (value = 100); age of data = 14 months (value = 85); resource cost = medium (value = 55); risk of loss/exfiltration = high (value = 100). A content security score can then be calculated for the file segment using the values assigned to the set of data importance indicators by, for example, summing the values, such that the file segment’s content security score = 340. As will be appreciated, these values are merely illustrative, the set of data importance indicators and associated values can be implemented by a person of ordinary skill using any appropriate value system, including non-numeric values, such as ordinal values (e.g., low, medium, high), as well as other types of known valuation techniques. Also, as will be appreciated, any appropriate mathematical operation can be used to calculate a content security score, including ranking and/or weighting the data importance indicators.

In some embodiments, file segments can be tagged to indicate an importance of the content data contained in the file segments, which can assist the file segmenting module 104 in determining content security scores for the file segments. Illustratively, a tag can be a description identifier of: a content value or level of importance (e.g., high, medium, low) of content data contained in a file segment; a keyword (e.g., project name, username, business unit, etc.) that is associated with a level of importance of the content data; an indication of increasing or diminishing importance of the content data (e.g., subject matter that is trending or dissipating in “the media”); as well as any other description identifier that persons of ordinary skill would utilize in tagging file segments. A tag can be provided by a user and/or may be generated by an automated process, such as an AI model that generates tags to indicate changes to importance of content data based on real-world events and developments, as will be described in more detail later. The file segmenting module 104 can evaluate a tag as part of generating a content security score for a file segment. For example, after generating a content security score for a file segment, the file segmenting module 104 can evaluate a tag for the file segment and modify the content security score accordingly. As an example, a low content security score generated for a file segment may be revised higher when a tag for the file segment indicates that the content data in the file segment is associated with a confidential project.

In some embodiments, the one or more AI models of the file segmenting module 104 can be trained using training datasets of labeled content data (e.g., historical content data and/or synthetic data) to generate content security scores, where the content data can be labeled with the data importance indicators described above. A file segment can be input to the AI model(s), and the AI model(s) make inferences of data importance indicator values for the file segment, which are output by the AI model(s). In artificial intelligence, an inference is the process of using a trained AI model to make predictions or classifications on new data.

In some embodiments, the one or more AI models can be updated to generate content security scores that account for real-world events and/or developments that may be associated with content data contained in a file 120. Because a real-world event or development related to content data can impact the importance of content data, the AI model(s) can be updated using information for the event or development to generate a content security score that reflects a change in the importance of the content data as a result of the real-world event or development. For example, a news story about an event (e.g., a product announcement) or a development (e.g., a trend in artificial intelligence) related to content data contained in a file 120 may increase an importance of the content data. The AI model(s) can be updated with the information in the news story to enable the AI model(s) to make inferences that are based in part on the information in the news story. As another example, content in a file 120 describing a proprietary technology may have high importance prior to publication of a patent application for the technology, and a lower importance after publication of the patent application. In the event that the patent application is published, the AI model(s) can be updated with information of the publication event to enable the AI model(s) make inferences that are based in part on the publication event. Additionally, the ability to determine what information is already in the public domain, or becomes available publicly at some point in time, allows the AI model(s) to determine when a higher security tier 112 for related content data would not be warranted as the information is already available from public sources.

Accordingly, information for real-world events and developments can be collected from various sources (e.g., the Internet, public and private databases, etc.), and the information can be used to update the one or more AI model(s). For example, the AI model(s) can be retrained or rebuilt using updated training datasets that include the new information, or an “online learning” or “continual learning” algorithm can be used to update the AI model(s) with the new information. Moreover, in some embodiments, tags indicating an importance of content data in file segments can be used to update the AI model(s). For example, a tag indicating that content data in a file segment is associated with a confidential project can be used to train the AI model(s) to recognize the content data as being associated with the confidential project.

In this illustrative example, as part of dividing a file 120 into file segments and generating content security scores for the file segments, the file segmenting module 104 can generate metadata for the individual file segments. For example, when segmenting a file 120, the file segmenting module 104 can identify file offsets for security separation boundaries of content data. The file offsets can be pointers to locations within the file 120 that indicate a start of content data and an end of content data that define the file segment. The metadata generated by the file segmenting module 104 can include these file offsets. In addition, the file segmenting module 104 can include a content security score for the file segment in the metadata, a timestamp for when the content security score was calculated, as well as any other useful information for the file segment known to persons of ordinary skill. After generating the metadata for the file segment, the file segmenting module 104 can provide the metadata to the other modules of the file segment security service 102. For example, the metadata can be provided to the file segment management module 108 for use in applying a security protocol to the file segment.

In this illustrative example, the file segment management module 108 assigns a security tier 112 to a file segment based on the file segment’s content security score. The file segment management module 108 makes this assignment by identifying a security tier 112 that corresponds to file segment’s content security score. As shown in FIG. 1, the file segment security service 102 interfaces with datastores 110 having defined security tiers 112. The datastores 110 include different levels of security tiers 112 for storing file segments. In some embodiments, the security tiers 112 can be located on different servers for implementing different data security protocols and/or data storage methods and hardware. As a non-limiting example, security tier 112A can be located on a first server reserved for high importance content data, security tier 112B can be located on a second server reserved for medium importance content data, and security tier 112N can be located on a third server reserved for low importance content data. Different levels of encryption can be used for storing the file segments to the security tiers 112. As a non-limiting example, an encryption standard that encrypts data both at rest (stored) and inflight (being transmitted) can be used to encrypt file segments assigned to a security tier (e.g., 112A) reserved for storing high importance content data; file segments assigned to a security tier (e.g., 112B) reserved for medium importance content data can be encrypted using a full disk encryption (FDE) standard; and file segments assigned to a security tier (e.g., 112N) reserved for low importance content data may not be encrypted. In some embodiments, in addition to the data security protocols, datastores 110 used for the security tiers 112 can be managed using a strategic approach that can be based on frequency of access and performance requirements.

In this illustrative example, the file segment management module 108 determines which security tier 112 to assign to a file segment based on the file segment’s content security score. In some embodiments, data score ranges can be used to determine which security tier 112 to assign to a file segment. As a non-limiting example, content security scores for file segments that fall between 0-100 can be assigned to a security tier (e.g., 112N) reserved for low importance content data; content security scores that fall between 101-300 can be assigned to a security tier (e.g., 112B) reserved for medium importance content data; and content security scores that are greater than 300 can be assigned to a security tier (e.g.,112A) reserved for high importance content data. After identifying a security tier 112 that corresponds to a content security score calculated for a file segment, the file segment management module 108 can generate metadata to indicate the security tier 112 assigned to the file segment and provide this metadata to the file segment management module 108.

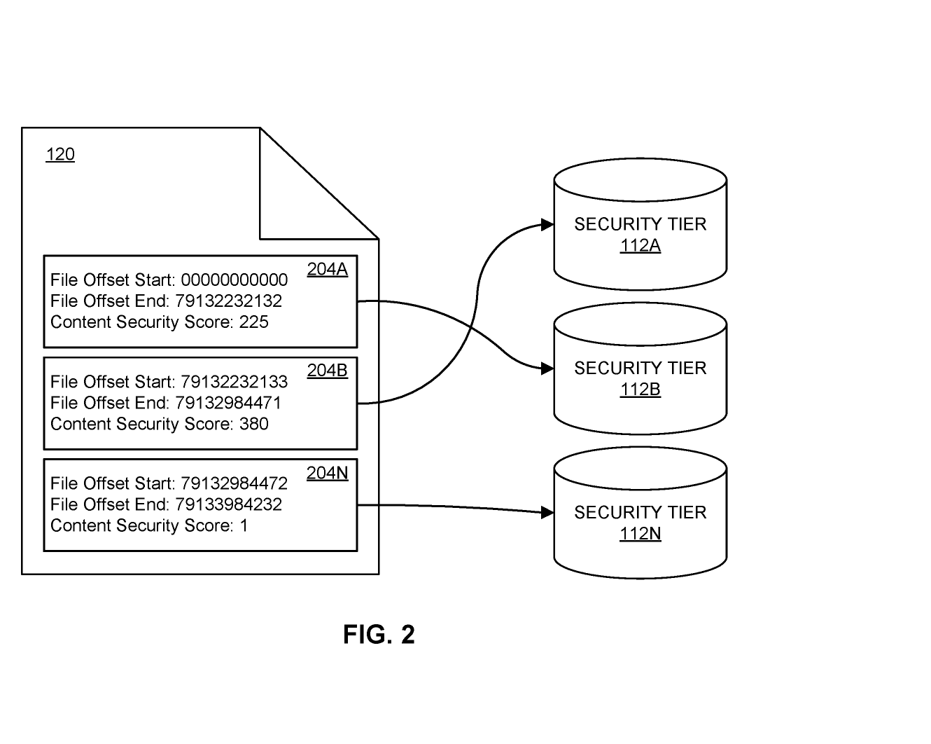

In this illustrative example, the file segment management module 108 manages storage and retrieval of file segments. Storing file segment can comprise using metadata received from the file segmenting module 104 to store respective file segments to datastores 110 that implement the security tiers 112 assigned to the file segments. As an example, illustrated in FIG. 2 with continuing reference to FIG. 1, assuming that file segments having content security scores between 0-199 are assigned to security tier 112N (low importance), and file segments having content security scores between 201-300 are assigned to security tier 112B (medium importance), and file segments having content security scores greater than 300 are assigned to security tier 112A (high importance), the file segment management module 108 performs the following. For file segment 204A, based on a content security score = 225, file segment 204A is assigned to security tier 112B (medium importance). For file segment 204B, based on a content security score = 380, file segment 204B is assigned to security tier 112A (high importance). And for file segment 204N, based on a content security score = 1, file segment 204N is assigned to security tier 112N (low importance). As part of identifying the security tiers 112 for the file segments 204A, 204B, 204N, the file segment management module 108 can obtain file offsets for the file segments 204A, 204B, 204N and extract the file segment file segments 204A, 204B, 204N from the file 120. The file segment management module 108 can then store the file segments 204A, 204B, 204N to datastores 110 that implement the security tiers 112.

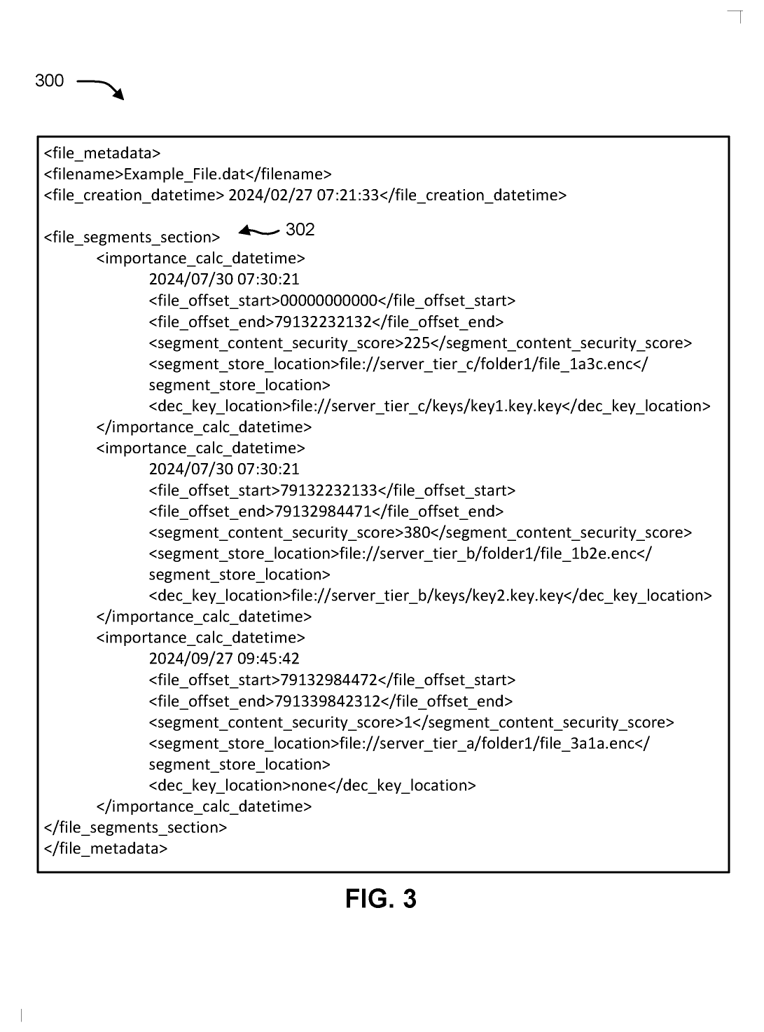

Returning to FIG. 1, in this illustrative example, the file segment management module 108 manages the metadata for file segments, including generating additional metadata, as described below. As indicated earlier, the file segment management module 108 receives metadata for file segments from the other modules of the file segment security service 102 and, as part of storing the file segments to the datastores 110 that implement the security tiers 112, the file segment management module 108 can generate additional metadata for the file segments, such as timestamps, storage locations, encryption information, as well as other appropriate metadata known to persons of ordinary skill. For example, FIG. 3 illustrates an example metadata file 300 containing metadata for example file segments, where the metadata can be created by the file segment management module 108 as part of storing the file segments to datastores 110 that implement the security tiers 112. As shown, the metadata file 300 can include a file segments section 302 containing information for the individual file segments. Metadata in the file segment section 302 can include, but is not limited to: a timestamp indicating when an importance of the file segment was last determined (e.g., when last a content security score was calculated for the file segment), file offsets indicating a portion of the source file (e.g., file 120 in FIG. 1 and FIG. 2) that contains the file segment, a content security score for the file segment, a storage location of the file segment, and an encryption key used to encrypt the file segment. As will be appreciated, in some embodiments, low importance file segments may not be encrypted.

Referring again to FIG. 1, the file segment management module 108, in some embodiments, can store metadata for a file segment with the file segment itself. For example, the metadata can be added to file segment (e.g., in a file header), and the file segment can be stored to a datastore 110 that implements a security tier 112 indicated in the metadata, such that the file segment and its metadata are stored according to the same security protocol. In other embodiments, metadata for a file segment can be stored separately from the file segment. For example, the metadata can be stored in a file system’s internal file, library database, data dictionary, metadata repository, metadata server or node, and the like. In those cases where the metadata itself is deemed to be sensitive/confidential data (e.g., a content security score for a file segment), the metadata can be encrypted using a different encryption key than that used to encrypt the respective file segment.

Retrieval of a file 120, which has been segmented using the techniques described above, can be performed by the file segment management module 108. In some embodiments, responsive to an instruction to retrieve a file 120, the file segment management module 108 can obtain metadata for the file 120 (which includes the information needed to reconstruct the file 120), retrieve the individual file segments from storage and reconstruct the file 120 in memory in accordance with the file’s metadata. In some embodiments, the file 120 can be reconstructed to correspond to a user-level security assigned to a user who is requesting the file 120. User-level security can assign different access levels to end-users based on their role and responsibilities. A user who is assigned full-access may view a file 120 in its entirety, whereas a user who is assigned limited-access may only view select file segments that correspond to the user’s limited-access level. Accordingly, in some embodiments, in response to a request for a file 120, the file segment management module 108 can be provided with a user’s access level, and the file segment management module 108 can retrieve the file segments of the file 120 that correspond to the user’s access level. If the user’s access level only allows the user to view low importance content data, then only those file segments containing low importance content data will be retrieved by the file segment management module 108 for reconstructing the file, which can then be provided to the user. In those cases where a user’s access level does not allow full access to a file 120, in some embodiments, the file segment management module 108 can add an indication (e.g., blank space, redacted symbol, etc.) to the portions of the file 120 that are missing file segments which do not correspond to the user’s access level.

The file segment security service 102 described above can be integrated with existing data storage and management platforms in order to implement the enhanced data security techniques described herein. The file segment security service 102 can perform assessments of content data importance when files 120 are created, modified, and also periodically to determine whether security tiers 112 assigned to the files 120 need to be updated. In some embodiments, the file segment security service 102 can monitor a user’s file directories and perform the techniques described herein on the files 120 contained in the user’s file directories. Alternatively, in some embodiments, a user can designate a dedicated file directory for the file segment security service 102, and the file segment security service 102 can perform the techniques described herein on the files 120 contained in the dedicated file directory.

The file segment security service 102, in some embodiments, can monitor a file 120 that has been segmented using the techniques described herein for changes made to the file 120, and in response to detecting that the file 120 has been changed, the file segment security service 102 can reevaluate the file 120 to determine whether security tiers currently assigned to the file segments need to be updated. In some embodiments, the file segment security service 102 reevaluates the file 120 as a whole, such that the current security boundaries defining current file segments are updated (if needed) to new security boundaries defining new file segments, and new content security scores are calculated for the new file segments, and thereafter, the new file segments are assigned to security tiers 112 that correspond to the new content security scores.

Alternatively in some embodiments, the file segment security service 102 monitors individual file segments for changes to content data using any method known to persons of ordinary skill, and if a change is detected, the file segment security service 102 reevaluates the file segment and updates a security protocol assigned to the file segment if needed. For example, in response to determining that a file segment has been modified, the file segment security service 102 can calculate a new content security score for the file segment and assign the file segment to a security tier 112 that corresponds to the new content security score. In the case that the new content security score corresponds to a different security tier 112 than that currently assigned to the file segment, the file segment can be reassigned to the security tier 112 that corresponds to the new content security score.

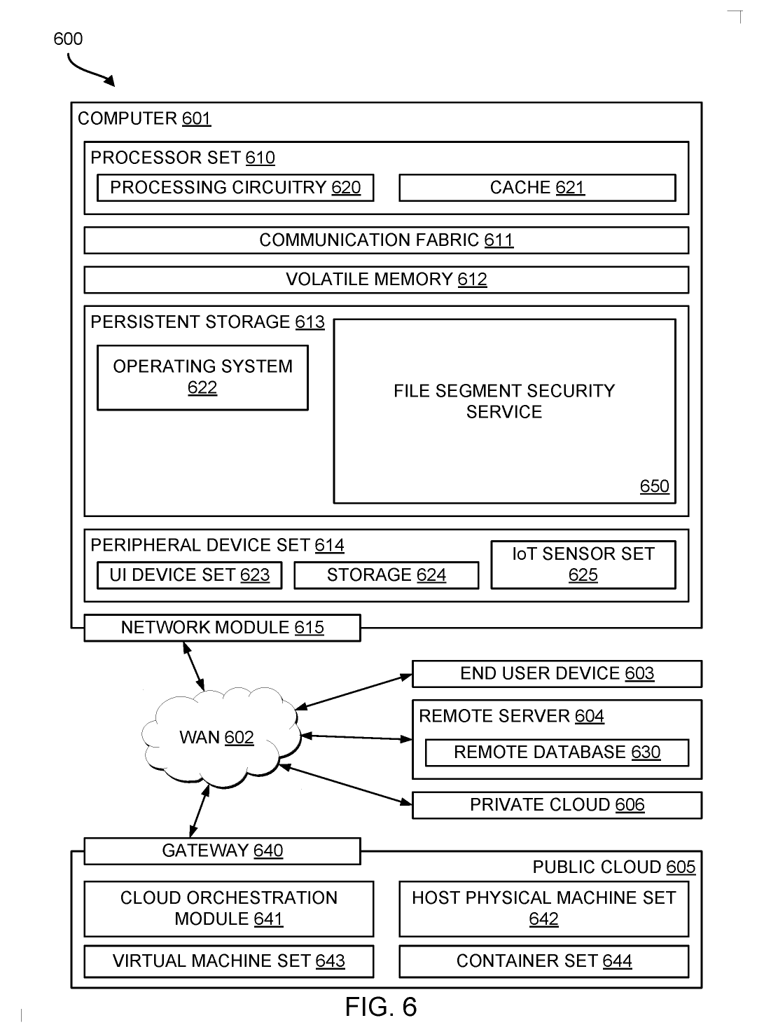

All or a portion of the system 100 shown in FIG. 1 can be implemented, for example by all or a subset of the computing environment 600 of FIG. 6. The file segment security service 102 can comprise any of a cloud service, a web server application, a client side application, an application plug-in (e.g., a word processor plug-in), and the like. The file segment security service 102 can be implemented in software, hardware, firmware or a combination thereof. When software is used, the operations performed by the file segment security service 102 can be implemented in program instructions configured to run on hardware, such as a processor. When firmware is used, the operations performed by the file segment security service 102 can be implemented in program instructions and data and stored in persistent memory to run on a processor. When hardware is employed, the hardware can include circuits that operate to perform the operations in the file segment security service 102.

Generally, modules (also referred to as program modules) include routines, programs, components and/or data structures that perform particular tasks and/or implement particular abstract data types. In some embodiments, the modules can be implemented as computing services hosted in a computing environment (e.g., the computing environment 600 of FIG. 6). For example, a module can be considered a service with one or more processes executing on a server or other computer hardware. Such services can provide a service application that receives requests and provides output to other services or consumer devices. An application programming interface (API) can be provided for each module to enable a first module to send requests to and receive output from a second module. Such APIs can also allow third parties to interface with the module and make requests and receive output from the modules.

Herein, terms such as “store,” “storage,” “datastore,” data storage,” “database,” and substantially any other information storage component relevant to operation and functionality of a component are utilized to refer to “memory components”, entities embodied in a “memory”, or components comprising a memory. Memory and/or memory components described herein can be either volatile memory or nonvolatile memory or can include both volatile and nonvolatile memory. Additionally, the described memory components of systems and/or computer-implemented methods herein are intended to include, without being limited to including, these and/or any other suitable types of memory.

In the illustrative examples above, the same reference numeral may be used in more than one figure. This reuse of a reference numeral in different figures represents the same element in the different figures. The illustration of system 100 in FIG. 1 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. While FIG. 1 illustrates an example of a system that can implement the techniques above, many other similar or different environments are possible.

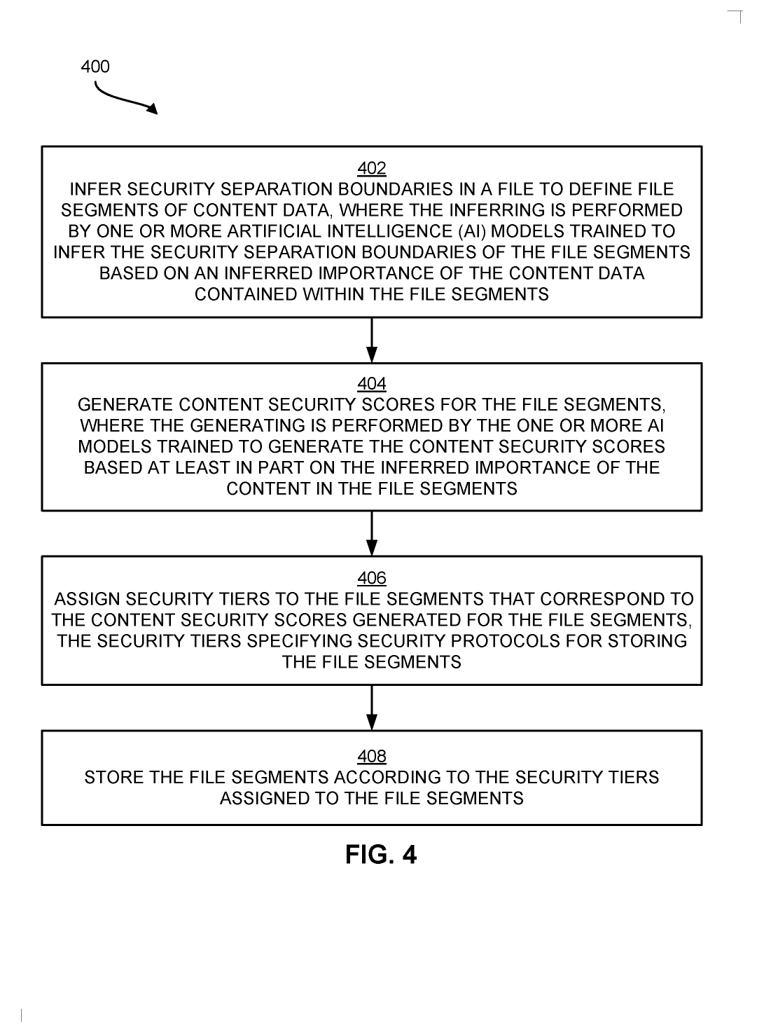

FIG. 4 is a flow diagram illustrating an example method 400 for securing content data contained in a file segment, in accordance with some embodiments of the present disclosure. As described earlier, prior data security systems use a one-size-fits all security approach for securing a file, as a whole, that can result in the over-protection of low importance – low risk content data contained in the file, and the under-protection of high importance – high risk content data contained in the file. The method 400 improves upon these prior data security systems by securing individual file segments of a file based on an importance of the content data contained in the individual file segments.

The method 400, in some embodiments, can be used to secure all of a user’s files (e.g., files stored on a user’s device or in a user’s network file system), or alternatively, certain files specified by a user (and/or a system administrator). For example, in some embodiments, the method 400 can monitor a dedicated file directory and, in response to detecting that a user has placed a file in the dedicated file directory, the method 400 can secure the content data contained in the file, as described below.

In operation 402, the method 400 infers security separation boundaries in a file to define file segments of content data, where the inferring is performed by one or more AI models that have been trained to infer the security separation boundaries of the file segments based on an inferred importance of the content data contained within the file segments. In some embodiments, the AI model(s) can be configured to use topic modeling techniques to identify the segments in a file. The topic modeling techniques can identify a file segment based on an inference of an importance of content data contained within the file segment. In some embodiments, inferring an importance of a file segment can comprise, but is not limited to, the features of: a content value of the file segment (e.g., the content data’s value to an organization and/or individual), a risk level based on a security protocol for securing the file segment, an impact cost of a data exfiltration and/or a data loss event, and/or a resource cost associated with creating and/or obtaining the content data contained in the file segment. The AI model(s) can infer an importance of content data in the file, and the AI model(s) can determine the security separation boundaries of the content data, which can comprise a page, a sequence of pages, a paragraph, a sequence of paragraphs, a portion of a paragraph, or another unit of the file, as will be appreciated by persons of ordinary skill. The security separation boundaries of the content data define a file segment, which can be represented using file offsets (e.g., a starting offset and an ending offset).

In operation 404, the method 400 generates content security scores for the file segments, where the generating of the content security scores can be performed by the one or more AI models trained to generate the content security scores based at least in part on the inferred importance of the content in the file segments. In some embodiments, a set of data importance indicators that represent features of content data contained in a file segment can be used to generate a content security score for the file segment. Illustratively, the set of data importance indicators can include, but are not limited to: a content category (e.g., public data, internal-only data, confidential data, high sensitivity data, medium sensitivity data, low sensitive data, specialized data, etc.); an age and/or relevance of content at a specified point-in-time; an amount of resources expended to generate/obtain content data; risks associated with the loss of, or the exfiltration of, content data (e.g., financial losses, productivity disruptions, reputational damage, legal consequences, etc.); an author of content data; and/or a job role of an author of content data. Each data importance indicator can be assigned a value to signify an importance of the feature represented by the data importance indicator, and a content security score can be calculated from the values of the data importance indicators.

In some embodiments, a file segment can be tagged with a description identifier that indicates an importance of the content data contained in the file segment. The tag can provide a hint for determining a content security score for the respective file segment. In cases where a file segment is tagged, the method 400 can determine an importance of the content data contained in the file segment based in part on the description identifier, and thereafter, generate a content security score for the file segment. Illustratively, a tag can be a description identifier of: a content value or level of importance (e.g., high, medium, low) of content data contained in a file segment; a keyword (e.g., project name, username, business unit, etc.) that is associated with a level of importance of the content data; an indication of increasing or diminishing importance of the content data (e.g., subject matter that is trending or dissipating in “the media”); as well as any other description identifier that persons of ordinary skill would utilize in tagging file segments.

After generating the content security scores, the method 400, in operation 406, assigns security tiers to the file segments that correspond to the content security scores generated for the file segments, where the security tiers specify security protocols for storing the file segments. In some embodiments, the security tiers comprise different levels of datastore security tiers. The datastore security tiers can be located on different servers the implement different data security protocols and/or data storage methods and hardware. Different levels of encryption can be used for storing the file segments to the datastore security tiers. In some embodiments, in addition to the data security protocols, the datastore security tiers can be managed using a strategic approach for storing file segments based on frequency of access and performance requirements.

In operation 408, the method 400 stores the file segments according to the security tiers assigned to the file segments. In some embodiments, as part of storing the file segments according to the security tiers, the method 400 encrypts a file segment that is assigned to a security tier that specifies a particular encryption technique for securing the file segment.

In some embodiments, as part of performing operations 402, 404, and 406, the method 400 generates metadata for the file segments to include information that can be used to store, retrieve, and reconstruct the file. Illustratively, the information can include: file segment offsets for a file segment, a last assessment timestamp for the file segment, a content security score for the file segment, a storage location of the file segment, encryption information for the file segment, as well as any other information that would be useful to persons of ordinary skill implementing the method 400. In some embodiments, the method 400 encrypts the metadata for a file segment and stores the metadata separate from the file segment (e.g., a file system’s internal file, library database, data dictionary, metadata repository, metadata server or node, and the like). In those cases where the metadata itself is sensitive/confidential data (e.g., a content security score for a file segment), the metadata can be encrypted using an encryption key that is different from an encryption key used to encrypt the respective file segment. In other embodiments, the method 400 stores the metadata for a file segment within the file segment itself according to the security tier assigned to the file segment.

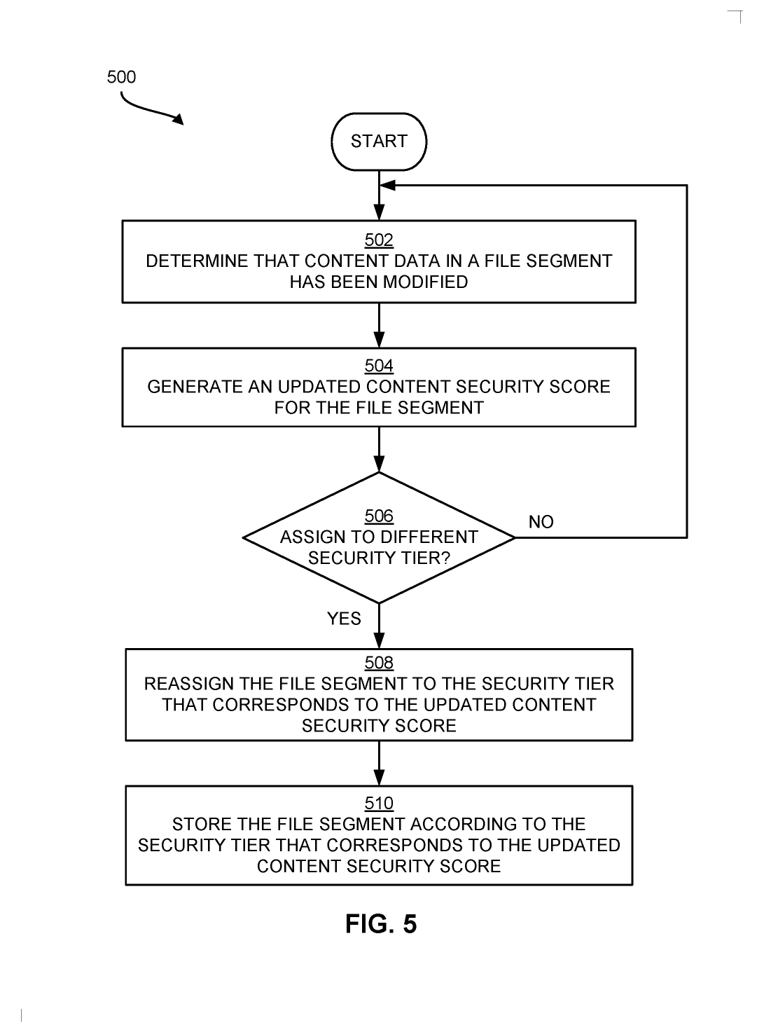

FIG. 5 is a flow diagram illustrating an example method 500 for updating a content security score for a file segment in response to a modification of the content data in the file segment, in accordance with some embodiments of the present disclosure. In some embodiments, the file segments of a file, which have been processed using the method 400 described in association with FIG. 4, can later be modified by a user. For example, over the lifetime of a file, a user may add or remove content from the file. The content that is added or removed can change the importance of the file segment. As such, aspects of the present disclosure can determine whether a modification to the content data of a file segment changes the importance of the file segment and reassign the file segment to a different security tier if needed.

More specifically, the method 500 in operation 502, determines that content data in a file segment has been modified. Illustratively, the method 500 can monitor a user’s file directories for modified files and/or periodically evaluate the file segments of a file to determine whether the security protocols assigned to the file segments should be updated. In an embodiment where the method 500 is implemented in an application plug-in, such as a word processor plug-in, the operations of method 500 below can be performed when the file is saved to a storage device.

In operation 504, the method 500 generates an updated content security score for the file segment. The updated content security score can be generated using the techniques described earlier. In operation 506, the method 500 determines whether the updated content security score generated for the file segment corresponds to a security tier that is different from the currently assigned security tier.

In the case that the updated content security score corresponds to a different security tier, then in operation 508, the method 500 reassigns the file segment to the security tier that corresponds to the updated content security score, and in operation 510, the method 500 stores the file segment according to the security tier that corresponds to the updated content security score. For example, consider the scenario where confidential data has been removed from a file segment, the method 500 may generate an updated content security score for the modified file segment that corresponds with a security tier that has lower security requirements as compared to that of a currently assigned security tier, and as such, the method 500 may store the file segment according to the lower security tier. In the scenario where high sensitivity data has been added to a file segment, the updated content security score for the modified file segment may correspond to a security tier that has higher security requirements as compared to the currently assigned security tier, and the file segment may be stored according to the higher security tier. In those cases where an updated content security score corresponds to a currently assigned security tier, no action is needed because the currently assigned security tier is appropriate for the file segment.

The methods 400 and 500 described above can be performed by a computer (e.g., computer 601 in FIG. 6), performed in a cloud environment (e.g., clouds 606 or 605 in FIG. 6), and/or generally can be implemented in fixed-functionality hardware, configurable logic, logic instructions, etc., or any combination thereof. In some alternative implementations of the illustrative embodiments, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage media or medium, as the terms are used in the present disclosure, are not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code involved in performing the disclosed methods, such as computer code in block 650 for a file segment security service that performs the techniques described herein to secure content data contained in a file segment. In addition to block 650, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 650, as identified above), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer-readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as cache 621 and the other storage media discussed below. The computer-readable program instructions, and associated data, are accessed by processor set 610 to control and direct performance of the disclosed methods. In computing environment 600, at least some of the instructions for performing the disclosed methods may be stored in block 650 in persistent storage 613.

COMMUNICATION FABRIC 611 is the signal conduction paths that allow the various components of computer 601 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid-state storage devices. Operating system 622 may take several forms, such as various known proprietary operating systems or open-source Portable Operating System Interface type operating systems that employ a kernel. The code included in block 650 typically includes at least some of the computer code involved in performing the disclosed methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer-readable program instructions for performing the disclosed methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. The terms “comprises,” “comprising,” “includes,” “including,” “has,” “having,” “contains” or “containing,” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus. As used herein, when used with reference to items, “a set of” means one or more of the items. For example, a set of AI models is one or more different types of AI models. Similarly, “a number of,” when used with reference to items, means one or more of the items. Moreover, “a group of” or “a plurality of” when used with reference to items, means two or more of the items. Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category. The term “user” refers to an entity (e.g., an individual(s), a computer, or an application executing on a computer).

In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure. Note further that numerous aspects or features are disclosed herein, and unless inconsistent, each disclosed aspect or feature is combinable with any other disclosed aspect or feature as desired for a particular application of the concepts disclosed.

As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art. Any advantages discussed in the present disclosure are example advantages, and embodiments of the present disclosure can exist that realize all, some, or none of any of the discussed advantages while remaining within the spirit and scope of the present disclosure.

The descriptions of the various aspects of the present invention have been presented for purposes of illustration, but are not intended to be exhaustive or limited to the approaches disclosed. Many modifications and variations will be apparent to those of ordinary skill in the art without departing from the scope and spirit of the described aspects. The terminology used herein was chosen to best explain the principles of the various aspects described, the practical application or technical improvement over technologies found in the marketplace, or to enable others of ordinary skill in the art to understand the approaches disclosed herein.

What is claimed is:

1. A computer-implemented method for securing content data contained in a file segment, comprising:
inferring security separation boundaries in a file to define file segments of content data, wherein the inferring is performed by one or more artificial intelligence (AI) models trained to infer the security separation boundaries of the file segments based on an inferred importance of the content data contained within the file segments;
generating content security scores for the file segments, wherein the generating is performed by the one or more AI models trained to generate the content security scores based at least in part on the inferred importance of the content in the file segments;
assigning security tiers to the file segments that correspond to the content security scores generated for the file segments, the security tiers specifying security protocols for storing the file segments; and
storing the file segments according to the security tiers assigned to the file segments.

2. The computer-implemented method of claim 1, wherein storing the file segments according to the security tiers further comprises encrypting file segments assigned to a security tier that specifies an encryption technique for securing the file segments.

3. The computer-implemented method of claim 1, further comprising generating metadata for a file segment to include information selected from the group consisting of: a content security score; a last assessment timestamp; and file segment offsets for the file segment.

4. The computer-implemented method of claim 3, further comprising:
encrypting the metadata for the file segment and storing the metadata separate from the file segment.

5. The computer-implemented method of claim 3, further comprising:
storing the metadata for the file segment in the file segment according to the security tier assigned to the file segment.

6. The computer-implemented method of claim 1, further comprising monitoring a dedicated file directory and, responsive to detecting that the file has been placed in the dedicated file directory, securing the content data contained in the file.

7. The computer-implemented method of claim 1, further comprising:
determining that a file segment of the file is tagged with a description identifier that indicates, at least in part, an importance of content data contained in the file segment; and
generating a content security score for the file segment based at least in part on the importance of the content data indicated by the description identifier.

8. The computer-implemented method of claim 1, further comprising:
determining that content data in a file segment has been modified;
generating an updated content security score for the file segment,
wherein responsive to a determination that the updated content security score corresponds to a security tier that is different from a currently assigned security tier,
reassigning the file segment to the security tier that corresponds to the updated content security score; and
storing the file segment according to the security tier that corresponds to the updated content security score.

9. The computer-implemented method of claim 1, wherein inferring an importance of a file segment comprises making inferences for the features selected from the group consisting of: a content value of the file segment, a risk level based on a current security protocol implemented for the file segment, an impact cost of a data exfiltration and/or a data loss event, and a data cost for creating and/or obtaining the content data contained in the file segment.

10. A computer system comprising:
a processor set;
one or more computer-readable storage media; and
program instructions stored on the one or more storage media to cause the processor set to perform operations comprising:
inferring security separation boundaries in a file to define file segments of content data, wherein the inferring is performed by one or more artificial intelligence (AI) models trained to infer the security separation boundaries of the file segments based on an inferred importance of the content data contained within the file segments;
generating content security scores for the file segments, wherein the generating is performed by the one or more AI models trained to generate the content security scores based at least in part on the inferred importance of the content in the file segments;
assigning security tiers to the file segments that correspond to the content security scores generated for the file segments, the security tiers specifying security protocols for storing the file segments; and
storing the file segments according to the security tiers assigned to the file segments.

11. The computer system of claim 10, wherein storing the file segments according to the security tiers further comprises encrypting file segments assigned to a security tier that specifies an encryption technique for securing the file segments.

12. The computer system of claim 10, wherein the operations further comprise:
generating metadata for a file segment to include information selected from the group consisting of: a content security score; a last assessment timestamp; and file segment offsets for the file segment.

13. The computer system of claim 10, wherein the operations further comprise:
monitoring a dedicated file directory and, responsive to detecting that the file has been placed in the dedicated file directory, securing the content data contained in the file.

14. The computer system of claim 10, wherein the operations further comprise:
determining that a file segment of the file is tagged with a description identifier that indicates, at least in part, an importance of content data contained in the file segment; and
generating a content security score for the file segment based at least in part on the importance of the content data indicated by the description identifier.

15. The computer system of claim 10, wherein the operations further comprise:
determining that content data in a file segment has been modified;
generating an updated content security score for the file segment,
wherein responsive to a determination that the updated content security score corresponds to a security tier that is different from a currently assigned security tier,
reassigning the file segment to the security tier that corresponds to the updated content security score; and
storing the file segment according to the security tier that corresponds to the updated content security score.

16. The computer system of claim 10, wherein inferring an importance of a file segment comprises making inferences for the features selected from the group consisting of: a content value of the file segment, a risk level based on a current security protocol implemented for the file segment, an impact cost of a data exfiltration and/or a data loss event, and a data cost for creating and/or obtaining the content data contained in the file segment.

17. A computer program product comprising:
one or more computer-readable storage media; and
program instructions stored on the one or more storage media to perform operations comprising:
inferring security separation boundaries in a file to define file segments of content data, wherein the inferring is performed by one or more artificial intelligence (AI) models trained to infer the security separation boundaries of the file segments based on an inferred importance of the content data contained within the file segments;
generating content security scores for the file segments, wherein the generating is performed by the one or more AI models trained to generate the content security scores based at least in part on the inferred importance of the content in the file segments;
assigning security tiers to the file segments that correspond to the content security scores generated for the file segments, the security tiers specifying security protocols for storing the file segments; and
storing the file segments according to the security tiers assigned to the file segments.

18. The computer program product of claim 17, wherein the operations further comprise:
generating metadata for a file segment to include information selected from the group consisting of: a content security score; a last assessment timestamp; and file segment offsets for the file segment.

19. The computer program product of claim 17, wherein the operations further comprise:
determining that content data in a file segment has been modified;
generating an updated content security score for the file segment,
wherein responsive to a determination that the updated content security score corresponds to a security tier that is different from a currently assigned security tier,
reassigning the file segment to the security tier that corresponds to the updated content security score; and
storing the file segment according to the security tier that corresponds to the updated content security score.

20. The computer program product of claim 17, wherein the operations further comprise:
generating metadata for a file segment to include information selected from the group consisting of: a content security score; a last assessment timestamp; and file segment offsets for the file segment.
